(19) United States
(12) Patent Application Publication
(10) Pub. No.: US 2016/0262378 A1
(43) Pub. Date: Sep. 15, 2016

(54) Small-Animal-Controlling Resin Composition

(71) Applicant: NIX, INC., Yokohama-shi, Kanagawa (JP)

(72) Inventors: Yuki MURASUGI, Sagamihara-shi (JP); Toru TAKAHASHI, Sagamihara-shi (JP)

(21) Appl. No.: 15/029,344

(22) PCT Filed: Oct. 10, 2014
(86) PCT No.: PCT/JP2014/077254

§ 371 Date: Apr. 14, 2016

(30) Foreign Application Priority Data
Oct. 15, 2013 (JP) 2013-214854

(51) Int. Cl. A01N 25/10; A01N 25/00; A01N 31/14; A01N 25/34

(52) U.S. Cl. CPC A01N 25/10; A01N 25/34; A01N 25/00; A01N 31/14

(57) ABSTRACT

Provided is a small-animal-controlling resin composition that makes it possible to mold a small-animal-controlling resin molded article that can be colored a desired color and has excellent weather resistance. The small-animal-controlling resin composition is configured to include at least a base resin, a small-animal-controlling agent, a sustained release auxiliary for the small-animal-controlling agent, an organic weatherproofing agent, and a metallic oxide particulate as an inorganic weatherproofing agent.

### TECHNICAL FIELD

The present invention relates to a small-animal-controlling resin composition obtained by mixing a small-animal-controlling agent in a base resin, and particularly, a method for increasing the weather resistance thereof.

### BACKGROUND ART

A small-animal-controlling resin composition, specifically, a small-animal-controlling resin composition which can be used outdoors, having a high weather resistance to ultraviolet light, heat, and water, and which brings about a small animal control effect over a long period of time has been sought. The applicants of the present application have previously proposed a composition comprising a base resin, a plasticizer, a small-animal-controlling agent, an inorganic filler, and additives which can control the formation of a film on the resin surface as a small-animal-controlling resin composition having a superior weather resistance. The additive which can control the formation of a film on the resin surface may include one or more selected from the group consisting of a hindered phenol-based antioxidant, a phosphorous-based antioxidant, a UV-absorbing light stabilizer, a hindered amine light stabilizer, and carbon (refer to claims of Patent Literature 1).

The small-animal-controlling resin composition described in Patent Literature 1 includes additives which can control the formation of a film on the resin surface, thus, when a small-animal-controlling resin molded article having a predetermined shaped which is molded from the small-animal-controlling resin composition is continuously used in an outdoor environment, and the like, which is exposed to high temperatures and water, it is difficult to form a film on the surface of the resin molded article. Therefore, it becomes difficult to prevent the movement of a small-animal-controlling agent contained on the inside of a molded article to the molded article surface, thus, a sustained release effect can be brought about over a long period for time by the synergistic effect of the plasticizer and the inorganic filler, and it is easier to maintain the small-animal control effect.

### CITATION LIST

### Patent Literature

Patent Literature 1: WO2009/069710

### SUMMARY OF INVENTION

### Technical Problem

However, the small-animal-controlling resin composition described in Patent Literature 1 is obtained by adding additives which can control the formation of a film on the resin surface, thus, while there is the effect which increases the sustained release of the small-animal-controlling agent, there is no effect for controlling the degradation of the resin composition itself due to UV light. Therefore, when used outdoors, the small-animal-controlling resin molded article easily deforms in a short period of time, and it is difficult to obtain the intended service life. Further, Patent Literature 1 provides organic and inorganic additives as the additives which can control the film formation of the resin surface, but with only organic additives, the weather resistance cannot be maintained in long term outdoor use. However, inorganic additives such as carbon have an effect on the improvement of the weather resistance, but when carbon is added to the small-animal-controlling resin composition, the color tone of the small-animal-controlling resin molded article which is the product becomes black, and coloring to other color tones becomes difficult, thus, there is the problem that inorganic additives cannot be used in the product in which the coloring to an intended color tone is sought.

The present invention was conceived in view of the above-described circumstances encountered in the conventional art, and the purpose thereof is to provide a small-animal-controlling resin composition that makes it possible to mold a small-animal-controlling resin molded article that can be colored a desired color and has excellent weather resistance.

### Solution to Problem

The present invention, in order to solve the aforementioned problems, is characterized by a small-animal-controlling resin composition comprising at least a base resin, a small-animal-controlling agent, a sustained release auxiliary for the small-animal-controlling agent, an organic weatherproofing agent, and metal oxide fine particles as an inorganic weatherproofing agent.

The metal oxide fine particles have a high light transparency in the visible light region, and, have a property for blocking ultraviolet light. Therefore, when metal oxide fine particles are added as a weatherproofing agent to the small-animal-controlling resin composition comprising a base resin, a small-animal-controlling agent, and a sustained release auxiliary for the small-animal-controlling agent, the small-animal-controlling resin composition does not become colored due to the addition of the weatherproofing agent, thus, the production of a small-animal-controlling resin molded article having the intended color tone becomes possible. Further, ultraviolet light can be blocked by the addition of metal oxide fine particles, thus, the deterioration of the base resin, the small-animal-controlling agent, and the sustained release auxiliary for the small-animal-controlling agent can be prevented or controlled, and the weather resistance of the small-animal-controlling resin molded article improves. Furthermore, the deterioration of the base resin, and the like due to light, high temperature, water, and the like can be prevented or controlled by the adding an organic weatherproofing agent.

Further, the present invention is characterized by the metal oxide fine particles in the small-animal-controlling resin composition having an average particle diameter of 1-100 nm.

The smaller the average particle diameter of metal oxide fine particles, the greater the light transparency in the visible light region and the greater the effect which blocks the ultraviolet light. However, if the average particle diameter of the metal oxide fine particles is too small, the dispersability to the base resin decreases. Therefore, by making the average particle diameter of the metal oxide fine particles to 1-100 nm, the transparency and the ultraviolet light blocking effect of the small-animal-controlling resin composition and the ease of the dispersion of the metal oxide fine particles can both be obtained.

Further, the present invention is characterized by the metal oxide fine particles in the small-animal-controlling resin composition having a maximum absorption wavelength of 200-450 nm.

By making the maximum absorption wavelength of the metal oxide fine particles to 200-450 nm, ultraviolet light can be efficiently blocked, and the weather resistance of the small-animal-controlling resin composition can increase.

Titanium oxide (maximum absorption wavelength 420 nm), zinc oxide (maximum absorption wavelength 380 nm), and cerium oxide (maximum absorption wavelength 400 nm) can be provided as the metal oxide fine particles having a maximum absorption wavelength of 200-450 nm.

Further, the present invention is characterized in that the surfaces of the metal oxide fine particles in the small-animal-controlling resin composition are subjected to a surface treatment using a surface treatment agent comprising an organic material.

It is difficult to uniformly disperse the metal oxide fine particles which are an inorganic material in the base resin, the small-animal-controlling agent, and the sustained release auxiliary for the small-animal-controlling agent which are organic materials. Therefore, if the surface of the metal oxide fine particles is subjected to a surface treatment using a surface treatment agent comprising an organic material, it becomes easy to uniformly disperse the metal oxide fine particles in the base resin, the small-animal-controlling agent, and the sustained release auxiliary for the small-animal-controlling agent, thus, the small-animal-controlling resin composition having excellent weather resistance can be stably produced.

Further, the present invention is characterized in that a low volatility carboxylic acid ester derivative having a boiling point of no less than 200° C. is used as the sustained release auxiliary for the small-animal-controlling agent in the small-animal-controlling resin composition.

If a low volatility carboxylic acid ester derivative having a high boiling point is used as the sustained release auxiliary for the small-animal-controlling agent, the reduction of the sustained release auxiliary can be prevented or controlled when manufacturing the small-animal-controlling resin molded article from the small-animal-controlling resin composition, thus, it is possible to manufacture a small-animal-controlling resin molded article in which the controlling effect of the small-animal is high. The boiling point of the low volatility carboxylic acid ester derivative is no less than 200° C., thus, a small-animal-controlling resin molded article in which the controlling effect of the small-animal is high can be obtained using the low volatility carboxylic acid ester derivative as the sustained release auxiliary for the small-animal-controlling agent.

### Advantageous Effects of Invention

In the small-animal-controlling resin composition of the present invention, metal oxide fine particles are added as the weatherproofing agent, thus, the small-animal-controlling resin composition does not become colored due to the addition of the weatherproofing agent, and the small-animal-controlling resin molded article having the intended color tone can be manufactured. Further, the small-animal-controlling resin composition of the present invention blocks ultraviolet light with the metal oxide fine particles, thus, the small-animal-controlling resin molded article having excellent weatherproofing agent can be obtained.

### DESCRIPTION OF EMBODIMENT

Below, the configuration of the small-animal-controlling resin composition according to the embodiments will be explained. The small-animal-controlling resin composition according to the embodiments comprises a base resin, a small-animal-controlling agent, a sustained release auxiliary for the small-animal-controlling agent, and one or more weatherproofing agents comprising at least metal oxide fine particles.

### [Base Resin]

The base resin may satisfy both moldability and mechanical strength required in a small-animal-controlling resin molded article, and is not specifically limited. Examples may include polyamide resin, polyacetal resin, polyethylene resin, polypropylene resin, polystyrene resin, polyethylene terephthalate resin, polybutylene terephthalate resin, polycarbonate resin, polyarylate resin, polyphenylene ether resin, thermoplastic polyurethane resin, liquid crystal polyester resin, and the like.

Specific examples of the polyamide resin may include polyamide resins such as Polyamide 6, Polyamide 66, Polyamide 11, and Polyamide 12 resin, and aromatic polyamide resins such as Polyamide MXD and Polyamide 6T resins.

Specific examples of the polyacetal resin, may include, in addition to a homopolymer comprising only an oxymethylene unit, a copolymer comprising an oxymethylene unit as the main component, and another copolymer unit such as an oxymethylene unit as an accessory component, a cross-linked polymer formed by crosslinking therebetween, or a graft copolymer formed by graft polymerization.

Specific examples of the polyethylene resin may include high-density polyethylene, low-density polyethylene, ultralow-density polyethylene, and linear low-density polyethylene.

Specific examples of the polypropylene resin may include a homopolymer of polypropylene, a random copolymer of ethylene and propylene, and a block copolymer.

Specific examples of the polystyrene resin may include, for example, a styrene homopolymer and a styrene-acrylic acid copolymer having styrene as the main component, styrene-methyl acrylate copolymer, styrene-ethyl acrylate copolymer, styrene-methacrylate copolymer, styrene-methyl methacrylate copolymer, styrene-ethyl methacrylate copolymer, styrene maleic anhydride copolymer, styrene-polyphenylene ether copolymer, styrene-butadiene copolymer, styrene-acrylonitrile copolymer, acrylonitrile-butadiene-styrene copolymer, styrene-methyl styrene copolymer, styrene-dimethyl styrene copolymer, styrene-ethyl styrene copolymer, styrene-diethyl styrene copolymer, and the like. The styrene component content in the aforementioned styrene copolymers is preferably no less than 50 mol %, and more preferably no less than 80 mol %.

The polymer obtained by polycondensation using terephthalate acid for the acid component and ethylene glycol for the glycol component can be used as polyethylene terephthalate resin, and in addition thereto, polymers obtained by polymerization with no more than 20 mol % of isophthalic acid, naphthalenedicarboxylic acid, adipic acid, sebacic acid, dodecane diacid, oxalic acid, and the like as the acid component; and propylene glycol, 1,4-butanediol, neopentyl glycol, 1,5-pentanediol, 1,6-hexanediol, decamethylene glycol, cyclohexanedimethanol, cyclohexanediol, and the like, or a long chain glycol having a molecular weight of 400-6000, i.e., polyethylene glycol, poly-1,3-propylene glycol, polytetramethylene glycol, and the like as the glycol component can be used.

The macromolecule having a structure by which the terephthalic acid unit formed ester bonds with the 1,4-butanediol unit, no less than 50 mol % of the dicarboxylic acid unit consists of the terephthalic acid unit, and no less than 50 mol % of the diol component consists of the 1,4-butanediol unit can be preferably used as the polybutylene terephthalate resin.

If the amount of terephthalic acid unit or the 1,4-butanediol unit is too small, for example, if less than 50 mol %, there are cases when the crystallization rate of the PBT resin decreases and the formability of the polybutylene terephthalate resin which can be obtained decreases. The percentage of the terephthalic acid unit in the whole dicarboxylic acid unit is preferably no less than 70 mol %, more preferably no less than 80 mol %, even more preferably no less than 95 mol %, and particularly preferably no less than 98 mol %, and the percentage of 1,4-butane diol unit in the whole diol unit is preferably no less than 70 mol %, more preferably no less than 80 mol %, even more preferably no less than 95 mol %, and particularly preferably no less than 98 mol %.

The dicarboxylic acid components other than terephthalic acid and which are the raw material of the polybutylene terephthalate resin are not specifically limited. For example, aromatic dicarboxylic acids such as phthalic acid, isophthalic acid, 4,4′-diphenyl dicarboxylic acid, 4,4′-diphenyl ether dicarboxylic acid, 4,4′-benzophenone dicarboxylic acid, 4,4′-diphenoxyethanedicarboxylic acid, 4,4′-diphenyl sulfone dicarboxylic acid, and 2,6-naphthalenedicarboxylic acid; alicyclic dicarboxylic acids such as 1,2-cyclohexane dicarboxylic acid, 1,3-cyclohexane dicarboxylic acid, and 1,4-cyclohexane dicarboxylic acid; aliphatic dicarboxylic acids such as malonic acid, succinic acid, glutaric acid, adipic acid, pimelic acid, suberic acid, azelaic acid, sebacic acid; and the like are exemplary. These dicarboxylic acid components may be introduced into the polymer framework as a dicarboxylic acid, or, using dicarboxylic acid derivatives such as a dicarboxylic acid ester or a dicarboxylic acid halide as a raw material.

Further, the diol components other than 1,4-butanediol which are the raw material of the polybutylene terephthalate resin are not specifically limited. For example, aliphatic diols such as ethylene glycol, diethylene glycol, polyethylene glycol, 1,2-propanediol, 1,3-propanediol, polypropylene glycol, polytetramethylene glycol, dibutylene glycol, 1,5-pentanediol, neopentyl glycol, 1,6-hexanediol, 1,8-octane diol, etc.; alicyclic diols such as 1,2-cyclohexanediol, 1,4-cyclohexanediol, 1,1-cyclohexane dimethylol, 1,4-cyclohexane dimethylol, etc.; and aromatic diols such as xylylene glycol, 4,4′-dihydroxy biphenyl, 2,2-bis(4-hydroxyphenyl)propane, bis(4-hydroxyphenyl)sulfone, etc. are exemplary.

Furthermore, the polybutylene terephthalate resin may be copolymerized with any conventionally well-known monomer unit. Examples of the monomer component may include a hydroxy carboxylic acid such as lactic acid, glycolic acid, m-hydroxy benzoic acid, p-β-hydroxy benzoic acid, 6-hydroxy-2-naphthalene carboxylic acid, p-hydroxy ethoxy benzoic acid, and the like; a mono-functional component such as alkoxy carboxylic acid, stearyl alcohol, benzyl alcohol, stearic acid, benzoic acid, t-butyl benzoic acid, benzoyl benzoic acid, and the like; a polyfunctional component of no less than trifunctional such as tricarbaryl acid, trimerit acid, trimesic acid, pyromellitic acid, gallic acid, trimethylol ethane, trimethylol propane, glycerol, pentaerythritol, and the like.

Examples of the polycarbonate resin may include a polymer obtained by the phosgene method which reacts various dihydroxydiaryl compounds with phosgene, or ester interchange which reacts a dihydroxydiaryl compound with a carbonic ester such as diphenyl carbonate, and an example of the representative resin may include the polycarbonate resin manufactured from 2,2-bis(4-hydroxyphenyl)propane (common name: bisphenol A).

Other than bisphenol A, examples of the dihydroxydiaryl compound include bis(hydroxyaryl)alkanes such as bis(4-hydroxyphenyl)methane, 1,1-bis(4-hydroxyphenyl)ethane, 2,2-bis(4-hydroxyphenyl)butane, 2,2-bis(4-hydroxyphenyl)octane, bis(4-hydroxyphenyl)phenylmethane, 2,2-bis(4-hydroxyphenyl-3-methyphenyl)propane, 1, 1-bis(4-hydoxy-3-tert-butylphenyl) propane, 2,2-bis(4-hydoxy-3-bromophenyl)propane, 2,2-bis (4-hydoxy-3,5-dibromophenyl)propane, 2,2-bis(4-hydoxy-3,5-dichlorophenyl)propane, bis(hydroxyaryl) cycloalkanes such as 1,1-bis (4-hydroxyphenyl)cyclopentane, 1,1-bis(4-hydroxyphenyl)cyclohexane, dihydroxydiaryl ethers such as 4,4′-dihydroxy-diphenyl ether and 4,4′-dihydroxy-3,3′-dimethyldiphenyl ether, dihydroxydiaryl sulfides such as 4,4′-dihydroxydiphenyl sulfide, dihydroxydiaryl sulfoxides such as 4,4′-dihydroxydiphenyl sulfoxide, 4,4′-dihydroxy-3,3′-dimethyldiphenyl sulfoxide, and dihydroxydiaryl sulfones such as 4,4′-dihydroxy-diphenylsulfone and 4,4′-dihydroxy-3,3′-dimethyldiphenyl sulfone, and the like.

These compounds may be used singly or two or more may be mixed, but in addition to these examples, piperazine, dipiperidyl hydroquinone, resorcin, 4,4′-dihydroxydiphenyl, and the like may be mixed and used. Furthermore, the dihydroxyaryl compound and the trivalent or higher phenol compounds as shown below may be mixed and used. Examples of a trivalent or higher phenol include fluoroglucine, 4,6-dimethyl-2,4,6-tri-(4-hydroxyphenyl)-heptane, 2,4,6-dimethyl-2,4,6-tri-(4-hydroxyphenyl)-heptane, 1,3,5-tri-(4-hydroxyphenyl)-benzol, 1,1,1-tri-(4-hydroxyphenyl)-ethane, and 2,2-bis-[4,4-(4,4′-dihydroxydihenyl)-cyclohexyl]-propane, and the like.

The viscosity average molecular weight of the polycarbonate resin is not specifically limited, but from the viewpoint of formability and strength, is ordinarily 10000-100000, and more preferably 15000-30000, and 17000-26000 is even more preferred. Further, when manufacturing a polycarbonate resin, a molecular weight adjusting agent, a catalyst, and the like may be used as needed.

A resin which makes an aromatic dicarboxylic acid residue and a bisphenol residue as repeating units may be used as the polyarylate resin. The polyarylate raw material for introducing the bisphenol residue is a bisphenol, and specific examples thereof include, for example, 2,2-bis(4-hydroxyphenyl)propane, 2,2-bis(4-hydroxy-3,5-dimethylphenyl)propane, 2,2-bis(4-hydroxy-3,5-dibromophenyl)propane, 2,2-bis(4-hydroxy-3,5-dichlorophenyl)propane, 4,4′-dihydroxy-diphenylsulfone, 4,4′-dihydroxy diphenyl ether, 4,4′-dihydroxy diphenyl sulfide, 4,4′-dihydroxy diphenyl ketone, 4,4′-dihydroxy diphenyl methane, 1,1-bis(4-hydroxyphenyl)cyclohexane and the like. These compounds may be used singly, or, two or more may be mixed and used. 2,2-bis(4-hydroxyphenyl)propane is economically preferable, and it is best to use this compound alone.

However, examples of the raw material for introducing the aromatic dicarboxylic acid residue into the polyarylate resin include terephthalic acid, isophthalic acid, orthophthalic acid, 1,5-naphthalene dicarboxylic acid, 2,6-naphthalene dicarboxylic acid, diphenic acid, 4,4′-dicarboxydiphenyl ether, bis(p-carboxylphenyl)alkane, 4,4′-dicarboxydiphenylsulfone, and the like, and thereamong, terephthalic acid and isophthalic acid are preferred. The polyarylate resin composition obtained by mixing and using terephthalic acid and isophthalic acid in the present invention is especially preferable from the viewpoints of melt-processibility and mechanical properties. The mixing ratio thereof (terephthalic acid/isophthalic acid) may be arbitrarily selected, but a molar ratio in the range of 90/10-10/90 is preferable, and 70/30-30/70 is more preferable, and 50/50 is most preferable. If the mixing molar ratio of terephthalic acid is less than 10 mol % or in excess of 90 mol %, there are cases when it is difficult to obtain a sufficient degree of polymerization by an interfacial polymerization method. From the viewpoint of the mechanical properties and the fluidity, it is desirable that the polyarylate resin has an intrinsic viscosity of 0.4-1.0, preferably 0.4-0.8, and more preferably 0.5-0.7.

The polyphenylene ether resin is a homopolymer and/or a copolymer including a repeating unit of the following Formula (I) and has a reduced viscosity (0.5 g/dl, chloroform solution, measured at 30° C.) of 0.15 to 1.0 dl/g. Furthermore, the reduced viscosity is more preferably 0.20 to 0.70 dl/g, and still more preferably 0.40 to 0.60 dl/g.

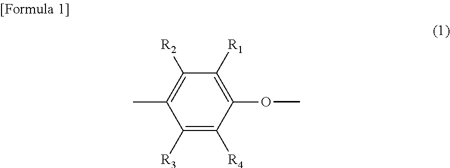

(R¹ and R⁴ independently represent, hydrogen, primary or secondary lower alkyl, phenyl, aminoalkyl, and oxy hydrocarbon. R² and R³ independently represent, hydrogen, primary or secondary lower alkyl, and phenyl) Specific examples of a polyphenylene ether resin include poly(2,6-dimethyl-1,4-phenylene ether), poly(2-methyl-6-ethyl-1,4-phenylene ether), poly(2-methyl-6-phenyl-1,4-phenylene ether), poly(2,6-dichloro-1,4-phenylene ether), and the like. Further, specific examples also include polyphenylene ether copolymers such as a copolymer of 2,6-dimethylphenol and another phenol (e.g., 2,3,6-trimethylphenol or 2-methyl-6-butylphenol). Thereamong, poly(2,6-dimethyl-1,4-phenylene ether) and a copolymer of 2,6-dimethylphenol and 2,3,6-trimethylphenol are preferred, and furthermore, poly(2,6-dimethyl-1,4-phenylene ether) is especially preferred.

An example of the method for producing the polyphenylene ether resin includes the method disclosed in U.S. Pat. No. 3,306,874 which subjects 2,6-xylenol to oxidation polymerization using a cuprous salt-amine complex as a catalyst. Methods disclosed in U.S. Pat. No. 3,306,875, U.S. Pat. No. 3,257,357, U.S. Pat. No. 3,257,358, JP-B-552-17880, JP-A-550-51197, and JP-A-563-152628 are also preferred as a method for producing the polyphenylene ether resin. The polyphenylene ether resin may be used in a powder form obtained after polymerization, or may be formed into pellets by melt-mixing the polyphenylene ether resin using an extruder or the like in a nitrogen gas atmosphere or an atmosphere other than nitrogen gas with or without devolatilization.

The polyphenylene ether resin also includes polyphenylene ether functionalized with a dienophile compound. Examples of the dienophile compound include maleic anhydride, maleic acid, fumaric acid, phenylmaleimide, itaconic acid, acrylic acid, methacrylic acid, methyl arylate, methyl methacrylate, glycidyl acrylate, glycidyl methacrylate, stearyl acrylate, and styrene. In order to functionalize the polyphenylene ether with the dienophile compound, the polyphenylene ether may be functionalized in a melted state using an extruder or the like in the presence or absence of a radical generator with or without devolatilization. The polyphenylene ether may be functionalized in an unmelted state (i.e. at room temperature or higher and at the melting point or less) in the presence or absence of a radical generator. The melting point of the functionalized polyphenylene ether is defined as the peak top temperature of the peak observed in a temperature-heat flow graph when increasing the temperature at 20° C./minute in the measurement using a differential scanning calorimeter (DSC). When multiple peak top temperatures exist, the melting point of the polyphenylene ether is defined as the highest peak top temperature.

The polyphenylene ether resin may comprise an aromatic vinyl polymer, and the like and resin components other than polyphenylene ether. Examples of an aromatic vinyl polymer include atactic polystyrene, high-impact polystyrene, syndiotactic polystyrene, and acrylonitrile-styrene copolymer. When the polyphenylene ether resin comprises polyphenylene ether resin and an aromatic vinyl polymer, the polyphenylene ether resin is made to no less than 70 wt %, and preferably no less than 80 wt % based on the total amount of the polyphenylene ether resin and the aromatic vinyl polymer.

A thermoplastic polyurethane resin containing polyisocyanate and polyol as the starting raw materials may be used, and thereamong, the amount of oxyethylene group in the thermoplastic polyurethane resin is no less than 40 mass % to no more than 65 mass %, thus, it is preferable that the softening temperature is no less than 160° C. by thermomechanical analysis (TMA) when making a film having a thickness of 20 μm.

A liquid crystal polyester resin which forms an anisotropic molten phase referred to as a “thermotropic liquid crystal polyester resin” by people having ordinary skill in the art is used. The properties of the anisotropic molten phase of the liquid crystal polyester resin can be verified by a general polarization inspection method using a cross polarizer, that is, observing a sample mounted on a hot stage in a nitrogen atmosphere. Moreover, the liquid crystal polyester resin used in the present invention includes the repeating units represented by the following Formula (2), and/or, the repeating units represented by Formula (3), and, two or more liquid crystal polyester resins in which the amount of the repeating units represented by Formula (2) is less than 40 mol % among all of the repeating units may be used as a blend.

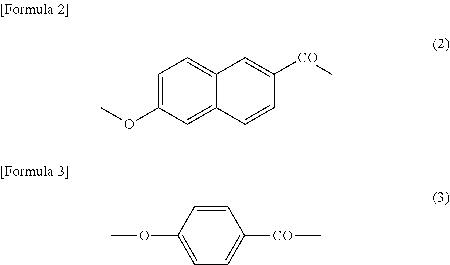

The liquid crystal polyester resin may be a semi-aromatic liquid-crystalline polyester resin having an aliphatic group in the molecular chain or a wholly aromatic liquid-crystalline polyester resin in which the molecular chain is entirely constructed of aromatic groups. Among these liquid crystal polyester resins, wholly aromatic liquid-crystalline polyester resins are preferable because of their flame retardancy and good mechanical properties. Examples of the repeating units used for preparing the liquid crystal polyester resin may include aromatic oxycarbonyl repeating units, aromatic di-carbonyl repeating units, aromatic dioxy repeating units, aromatic oxy dicarbonyl repeating units, and aliphatic dioxy repeating units. The liquid crystal polyester resin may include according to need among each of the repeating units, the 6-oxy-2-naphthoyl repeating units represented by Formula (2), and/or, the para-oxybenzoyl repeating units represented by Formula (3) as the aromatic oxycarbonyl repeating units.

In the liquid crystal polyester resin, the amount of the repeating units represented by Formula (2) is less than 40 mol % among all of the repeating units, and preferably no more than 35 mol %, and more preferably no more than 30 mol % in order to show that the obtainable liquid crystal polyester resin composition has a high toughness (impact strength). In the liquid crystal polyester resin, the amount of the repeating units represented by Formula (3) among all of the repeating units is not specifically limited as long as the object of the present invention can be achieved and the amount among all of the repeating units of the repeating units represented by Formula (2) is less than 40 mol %, but is preferably no more than 80 mol %, and is more preferably no more than 75 mol %.

An example of the monomer which provides the repeating units of Formula (2) may include 6-hydroxy-2-naphthoic acid, and an example of the monomer which provides the repeating units of Formula (3) may include para-hydroxybenzoic acid. These monomers may be used as ester forming derivatives such as acyl compounds, ester derivatives, and acid halides.

When the liquid crystal polyester resin is constructed from only the repeating units represented by Formula (2) and Formula (3), the amount of the repeating units represented by Formula (2) among all of the repeating units of the liquid crystal polyester resin is preferably 15-30 mol %, and more preferably 20-30 mol %.

The liquid crystal polyester resin may include aromatic oxycarbonyl repeating units other than Formula (2) and Formula (3). Specific examples of monomers which provide aromatic oxycarbonyl repeating units other than Formula (2) and Formula (3) include m-hydroxybenzoic acid, o-hydroxybenzoic acid, 5-hydroxy-2-naphthoic acid, 3-hydroxy-2-naphthoic acid, 4′-hydroxyphenyl-4-benzoic acid, 3′-hydroxyphenyl-4-benzoic acid, 4′-hydroxyphenyl-3-benzoic acid, and alkyl-, alkoxy- or halogen-substituted derivatives thereof as well as alkyl-, alkoxy- or halogen-substituted derivatives of 6-hydroxy-2-naphthoic acid and para-hydroxybenzoic acid. These monomers may also use ester forming derivatives such as acyl compound, ester derivative, and acid halide.

In the present invention, the whole aromatic liquid crystal polyester resin preferably consists of the repeating units represented by Formula (2), and/or, the repeating units represented by Formula (3), and the aromatic di-carbonyl repeating units and the aromatic dioxy repeating units. Furthermore, the amounts of the repeating units represented by Formula (2) and the repeating units represented by Formula (3) of the entire aromatic liquid crystal polyester resin is 50-90 mol % among all of the repeating units, and, the amounts of the aromatic dioxy repeating units and the aromatic di-carbonyl repeating units are substantially equimolar. When the aforementioned liquid crystal polyester resin includes the aromatic di-carbonyl repeating units and the aromatic dioxy repeating units, it is preferable that the amount of all of the repeating units of the liquid crystal polyester resin of both repeating units are substantially equimolar. The fact that the amounts of the aromatic di-carbonyl repeating units and the aromatic dioxy repeating units are substantially equimolar means that the ratio of the amount (mol %) of both repeating units in the liquid crystal polyester resin is 95/100-100/95.

In the liquid crystal polyester resin, specific examples of monomers which provide aromatic di-carbonyl repeating units may include aromatic dicarboxylic acid such as terephthalic acid, isophthalic acid, 2,6-naphthalene dicarboxylic acid, 1,6-naphthalene dicarboxylic acid, 2,7-naphthalene dicarboxylic acid, 1,4-naphthalene dicarboxylic acid, and 4,4′-carboxybiphenyl, and alkyl-, alkoxy or halogen-substituted derivatives thereof, as well as their ester derivatives, and ester forming derivatives such as acid halides. Thereamong, terephthalic acid and 2,6-naphthalene dicarboxylic acid are preferable in terms of controlling the mechanical properties, heat resistance, melting point and the molding properties of the resulting liquid-crystalline polyester resin to a suitable level.

In the liquid crystal polyester resin, specific examples of monomers which provide the aromatic dioxy repeating units may include aromatic diols such as hydroxyquinone, resorcin, 2,6-dihydroxynaphthalene, 2,7-dihydroxy-naphthalene, 1,6-dihydroxy-naphthalene, 1,4-dihydroxy-naphthalene, 4,4′-dihydroxybiphenyl, 3,3′-dihydroxybiphenyl, 3,4′-dihydroxybiphenyl, 4,4′-dihydroxybiphenyl ether, alkyl-, alkoxy- or halogen-substituted derivatives thereof, as well as ester forming derivatives such as acyl derivatives thereof. Thereamong, hydroquinone, resorcin, and 4,4′-dihydroxybiphenyl are preferable in terms of the good reactivity during the polymerization and the properties of the resulting liquid crystal polyester resin.

In the liquid crystal polyester resin, specific examples of monomers which provide aromatic oxy dicarbonyl repeating units may include hydroxy aromatic dicarboxylic acids such as 3-hydroxy-2,7-naphthalene dicarboxylic acid, 4-hydroxyisophthalic acid, and 5-hydroxyisophthalic acid, and alkyl-, alkoxy- or halogen-substituted derivatives thereof as well as ester forming derivatives such as acyl compound, ester derivative, and acid halide.

In the liquid crystal polyester resin used in the present invention, specific examples of monomers which provide aliphatic dioxy repeating units may include aliphatic diols such as ethylene glycol, 1,4-butanediol, 1,6-hexanediol and their acyl compounds.

In addition, liquid-crystalline polyester resins having an aliphatic dioxy repeating unit can be obtained by reacting polyesters having the aliphatic dioxy repeating unit such as polyethylene terephthalate or polybutylene terephthalate with the aromatic oxycarboxylic acid, aromatic dicarboxylic acid, aromatic diol or acyl compound, ester derivative, or acid halide thereof.

The liquid-crystalline polyester resin may have amide bonds or thioester bonds as long as the bond does not impair the object of the present invention. Examples of monomers which provide amide bonds or thioester bonds may include aromatic hydroxyamine, aromatic diamine, aromatic aminocarboxylic acid, mercapto-aromatic carboxylic acid, aromatic dithiol, and aromatic hydroxythiol. The amount of these monomers based on the total amount of monomers which provide the aromatic oxycarbonyl repeating unit, aromatic di-carbonyl repeating unit, aromatic dioxy repeating unit, aromatic oxy dicarbonyl repeating unit, and aliphatic dioxy repeating unit is preferably no more than 10 mol %. A liquid crystal polyester resins composed of these repeating units include those which form and those which do not form the anisotropic molten phase depending on the configuration of the monomer, the composition ratio, the sequence distribution of each of the repeating units in the polymer, but the liquid crystal polyester resins used in the present invention are limited to those which exhibit the anisotropic molten phase.

The preferred examples of the liquid crystal polyester resin have the following monomer configuration units.
(1) 4-hydroxybenzoic acid/2-hydroxy-6-naphthoic acid copolymer
(2) 4-hydroxybenzoic acid/terephthalic acid/4,4′-dihydroxybiphenylcopolymer
(3) 4-hydroxybenzoic acid/terephthalic acid/isophthalic acid/4,4′-dihydroxybiphenylcopolymer
(4) 4-hydroxybenzoic acid/terephthalic acid/isophthalic acid/4,4′-dihydroxybiphenyl/hydroquinone copolymer
(5) 4-hydroxybenzoic acid/terephthalic acid/hydroquinone copolymer
(6) 2-hydroxy-6-naphthoic acid/terephthalic acid/hydroquinone copolymer
(7) 4-hydroxybenzoic acid/2-hydroxy-6-naphthoic acid/terephthalic acid/4,4′-dihydroxybiphenylcopolymer
(8) 2-hydroxy-6-naphthoic acid/terephthalic acid/4,4′-dihydroxybiphenylcopolymer
(9) 4-hydroxybenzoic acid/2-hydroxy-6-naphthoic acid/terephthalic acid/hydroquinone copolymer
(10) 4-hydroxybenzoic acid/2,6-naphthalene dicarboxylic acid/4,4′-dihydroxybiphenyl copolymer
(11) 4-hydroxybenzoic acid/terephthalic acid/2,6-naphthalene dicarboxylic acid/hydroquinone copolymer
(12) 4-hydroxybenzoic acid/2,6-naphthalene dicarboxylic acid/hydroquinone copolymer
(13) 4-hydroxybenzoic acid/2-hydroxy-6-naphthoic acid/2,6-naphthalene dicarboxylic acid/hydroquinone copolymer
(14) 4-hydroxybenzoic acid/terephthalic acid/2,6-naphthalene dicarboxylic acid/hydroquinone/4,4′-dihydroxybiphenyl copolymer
(15) 4-hydroxybenzoic acid/terephthalic acid/ethylene glycol copolymer
(16) 4-hydroxybenzoic acid/terephthalic acid/4,4′-dihydroxybiphenyl/ethylene glycol copolymer
(17) 4-hydroxybenzoic acid/2-hydroxy-6-naphthoic acid/terephthalic acid/ethylene glycol copolymer
(18) 4-hydroxybenzoic acid/2-hydroxy-6-naphthoic acid/terephthalic acid/4,4′-dihydroxybiphenyl/ethylene glycol copolymer, and
(19) 4-hydroxybenzoic acid/terephthalic acid/2,6-naphthalene dicarboxylic acid/4,4-dihydroxybiphenyl copolymer.

Thereamong, as the thermostability and mechanical properties are excellent, a copolymer selected from the aforementioned (1), (13), or (19) is preferably used as the liquid crystal polyester resin. The crystal melting temperature (Tm) of the liquid crystal polyester resin measured by a differential scanning calorimeter is not specifically limited, but 320-380° C. is preferable from the point of the thermostability, 325-380° C. is more preferable, and 330-380° C. is most preferable.

Note that, the crystal melting temperature (Tm) may be measured by the method described below.

### <Crystal Melting Temperature Measurement Method>

An Exstar 6000 (manufactured by Seiko Instruments Inc., Chiba, Japan) was used as the differential scanning calorimeter. The liquid crystal polyester resin sample to be examined is heated at the rate of 20° C./minute and endothermic peak (Tm1) is recorded. Thereafter, the liquid crystal polyester resin sample is maintained at a temperature 20-50° C. higher than Tm1 for 10 minutes. Then the sample is cooled to room temperature at the rate of 20° C./minute and furthermore, the endothermic peak is observed when measuring while heating again at the rate of 20° C./minute, and the temperature indicating the peak top is deemed to be the crystal melting temperature (Tm) of the liquid crystal polyester resin. Further, the deflection temperature under load of the liquid crystal polyester resin used in the present invention as measured according to ASTM D648 is preferably 270-340° C., more preferably 280-340° C., and most preferably 290-340° C.

### <Deflection Temperature Under Load Measurement Method>

The deflection temperature under load was measured using an injection molding device (UH 1000-100 manufactured by Nissei Plastic Industrial Co., Ltd) to form a strip specimen having a length of 127 mm and a thickness of 3.2 mm, and the specimen was measured under the conditions of a load of 1.82 MPa and a temperature elevation rate of 2° C./minute according to ASTM D648.

Furthermore, the melting viscosity of the liquid crystal polyester resin used in the present invention measured with a capillary rheometer is preferably 10-100 Pa·s, more preferably 10-80 Pa·s, and most preferably 10-60 Pa·s.

### <Melting Viscosity Measurement Method>

The melting viscosity was sought using a melting viscosity measurement device (Capilograph 1D manufactured by Toyo Seiki Kogyo Co., Ltd) and the viscosity at a shear rate of 10³ s⁻¹ under the temperature conditions of the crystal melting temperature (Tm)+30° C. was measured in a capillary having a diameter of 0.7 mmφ and a length of 10 mm.

Any one of the above mentioned resins or a mixture of two or more resins selected from these can be used as the base resin. Furthermore, resin materials other than the above mentioned resin may be added. Below, an example of the composition of the base resin is shown.

### <Composition of Resin>

The base resin of the small-animal-controlling resin composition according to the present invention is preferably made with the following composition. Namely, the base resin of the small-animal-controlling resin composition is preferably comprised of (A1) olefin resin, (A2) polyamide resin, and at least one resin material selected from (A3) maleic anhydride-modified polyester, maleic anhydride-modified polypropylene, maleic anhydride-modified styrene-ethylene-butylene block copolymer, and ethylene-glycidyl methacrylate copolymer. Further, the base resin is preferably comprised of (A1) olefin resin, and (A4) at least one resin material selected from the group consisting of ethylene-vinyl carboxylate copolymer, and ethylene-unsaturated carboxylic acid ester copolymer. Furthermore, the base resin is preferably comprised of (A1) olefin resin, (A2) polyamide resin, and at least one selected from the resin material (A3) and at least one selected from the resin material (A4).

Olefin resin (A1) is a matrix resin for forming the small-animal-controlling resin composition as structure, and has polyethylene resin and polypropylene resin therein. A low density polyethylene resin (PE-LD), a high density polyethylene resin (PE-HD), a super density polyethylene resin (PE-VLD), and a linear low-density polyethylene (PE-LLD) can be used as the polyethylene resin. Further, a homopolymer, an ethylene-propylene copolymer, and a block copolymer can be used as the polypropylene resin.

The polyamide resin (A2) is a carrier resin for carrying the small-animal-controlling agent (B), and has the function for controlling the amount of the small-animal-controlling agent (B) contained in the olefin resin (A1). Examples of the polyamide resin (A2) include ε-capramide (PA6), hexamethylene adipamide (PA66), hexamethylene sebacamide (PA610), undecane lactam (PA11), ω-lauroamide (PA12), and {ε-capramide/hexamethylene adipamide/hexamethylene sebacamide/ω-lauroamide} copolymer.

The resin material (A3) is a dispersion auxiliary resin for increasing the compatibility of polyamide resin (A2) to olefin resin (A1), and has the function for uniformly dispersing the polyamide resin (A2) in the olefin resin (A1). Examples of the resin material (A3) include maleic anhydride-modified polyethylene (PE-MAH), maleic anhydride-modified polypropylene (PP-MAH), maleic anhydride-modified styrene-ethylene-butylene block copolymer (SEBS-MAH), and ethylene-glycidyl methacrylate copolymer (E-GMA, E-GMA-VA, and E-GMA-M)).

The resin material (A4) is an affinity resin for increasing the affinity of the small-animal-controlling agent (B) to the olefin resin (A1), and has the function for controlling the amount of sustained-release of the small-animal-controlling agent (B) from the olefin resin (A1). An example of the resin material (A4) includes ethylene-vinyl carboxylate copolymer or ethylene-unsaturated carboxylic acid ester copolymer, and more specifically, includes ethylene-vinyl acetate copolymer (EVA), ethylene-methyl methacrylate copolymer (EMMA), ethylene-methyl acrylate copolymer (EMA), and ethylene-ethyl acrylate copolymer (EEA).

### [Small-Animal-Controlling Agent]

The small-animal-controlling agent is a chemical agent exhibiting pesticidal activity against various agricultural harmful insects, insanitary insects or pests such as any other insects, spiders, mites or rats, and may include compounds exhibiting a small-animal repellent activity, compounds exhibiting insecticidal, miticidal, spidercidal, rodenticidal or any other pesticidal activity, compositions exhibiting small-animal antifeedant activity, compositions exhibiting pest growth control activity, and the like.

Specific examples of the small-animal-controlling agent may include chloronicotinyl insecticides such as an imidacloprid insecticide, a compound comprised of neophylradical having silicon atoms such as silafluofen, carbamate compounds such as benfuracarb, alanicarb, metoxadiazone, carbosulfan, phenobcarb, carbaryl, methomyl, propoxur and phenoxycarb, pyrethroid compounds such as pyrethrin, allethrin, d1, d-T80-allethrin, d-T80-resmethrin, bioallethrin, d-T80-phthalthrin, phthalthrin, resmethrin, furamethrin, proparthrin, permethrin, acrinathrin, etofenprox, tralomethrin, phenothrin, d-phenothrin, fenvalerate, empenthrin and prarethrin, tefluthrin, and benfluralin, organophosphorous compounds such as dichlorovos, fenitrothion, diazinon, malathon, propaphos, fenthion, trichlorfon, naled, temephos, fenclophos, chlorpyriphosmethyl, ciafos, calcrofos, azamethiphos, pyridafenthion, propetamphos and chlorpyriphos, as well as their isomers, derivatives and affinities. Further, compounds have the activity for controlling growth of the small animal such as methoprene, pyriproxyfen, kinoprene, hydroprene, dinotefuran, NC-170, flufenoxuron, diflubenzuron, lufenuron, and chlorfluazuron. Further, examples of miticides include kelthane, chlorfenapyr, tebufenpyrad, pyridaben, milbemectin, and fenpyroximate, and examples of rodenticides include scilliroside, norbormide, zinc phosphide, thallium sulfate, yellow phosphor, antu, warfarin, endocide, coumarine, coumatetralyl, bromadiolone and difethialone.

Furthermore, hinokitiol contained in Chamaecyparis taiwanensis (Taiwan hinoki), Thujopsis dolabrata (Asunaro), Thujopsis dolabrate (Japanese cypress) (Aomori khiva), and the like, cadinol derivatives (α-cadinol and T-cadinol) contained in herbs and hinoki, geraniol included largely in fragrant oil plants such as cloves, nutmeg, cilantro, and cumin, pinene, caryophyllene, borneol, eugenol, and the like, and furthermore, naturally-derived drugs such as well-known fragrant oils having a small-animal control ability such as those derived from Miscanthus sacchariflorus may be used as drugs having a small-animal control ability in the present invention.

### [Sustained Release Auxiliary for the Small-Animal-Controlling Agent]

The sustained release auxiliary for the small-animal-controlling agent provides the sustained release of the small-animal-controlling agent to the base resin, and is not specifically limited so long as plasticity is provided to the base resin, but specifically, at least one compound selected from sulfonamide derivatives, sulfonic acid ester derivatives, carboxylic acid amide derivatives, carboxylic acid ester derivatives is preferable. It is thought that these compounds melt and hold the small-animal-controlling agent, and have an action for providing the sustained release. The sustained release auxiliary for the small-animal-controlling agent increases the weather resistance of the small-animal-controlling resin composition, and thus, preferably uses a material having a boiling point of no less than 200° C.

Examples of the carboxylic acid ester derivative include, among the above mentioned sustained release auxiliaries for the small-animal-controlling agent, alkyl esters, aromatic esters, and the like of various carboxylic acids which may be substituted with a hydroxyl group, a nitro group, an amino group, an epoxy group, a halogen and the like, and those compounds having a hydroxyl group or an epoxy group are preferable as the compatibility with polyamide is good.

Specific examples of the carboxylic acid ester derivative may include phthalic acid ester derivatives such as dimethyl phthalate, diethyl phthalate, di-n-octyl-phthalate, diphenyl phthalate, benzyl phthalate, dimethoxy-ethyl-phthalate, 4,5-epoxy-hexahydro-phthalic-acid-di(2-ethyl hexyl), 4,5-epoxy-cyclohexahydro-phthalic-acid (7,8-epoxy-2-octenyl), 4,5-epoxy-cyclohexahydro-phthalic-acid-di(9,10-epoxyoctadecyl), 4,5-epoxy-cyclohexahydro-phthalic-acid-(10,11-epoxyundecyl), phthalic-acid-di(tetrahydrofurfuryloxyethyl), various phthalic acid mixed esters and an ethylene oxide adduct of a phthalic acid mixed ester, isophthalic acid ester derivatives, tetrahydrophthalic acid ester derivatives, benzoic acid ester derivatives such as parahydroxy benzoic acid butoxyethyl, parahydroxy benzoic acid cyclohexyloxy ethoxy ethoxyethyl, parahydroxy benzoic acid 2-ethylhexyl, hydroxybenzoic acid ester of ω-alkyl (oligo) ethylene oxide and a parahydroxy benzoic acid adduct of an undecyl glycidyl ether, propionic acid ester derivatives such as thiodipropionic acid di(tetrahydrofurfuryloxy ethyl), adipic acid ester derivatives, azelaic acid ester derivatives, sebacic acid ester derivatives, dodecane-2-acid ester derivatives, maleic acid ester derivatives, fumaric acid ester derivatives, trimellitate ester derivatives, citric acid ester derivatives such as tri(buthoxy ethoxyethyl)citrate, di-n-octyl-mono(nonyl phenoxy ethyl)citrate, tri-n-octyl citrate, dioctyl(tetrahydrofurfuryloxy ethyl)citrate, trimyristyl citrate and triethyl citrate, itaconic acid ester derivatives, oleic acid ester derivatives such as tetrahydrofurfuryl oleate, ricinoleic acid ester derivatives, lactic acid ester derivatives such as (n-butyl)lactate, (2-ethylhexyl)lactate, (n-buthoxyethoxyethyl)lactate, (n-octoxyethoxyethyl) lactate and (n-decyloxyethoxyethyl)lactate, tartaric acid ester derivatives such as di(ethoxyoctoxyethyl)tartrate, (n-octyl) (nonylphenoxyethyl)tartrate, and di(octoxyethoxyethyl) tartrate, malic acid ester derivatives such as dibutoxyethyl malate, di(n-butoxyethoxyethyl)malate, distearyl malate and octadecinyl isononyl malate, salicylic acid ester derivatives such as a salicylic acid adduct of an benzyl glycidyl ether, and the like. Further, specific examples of the phosphoric acid ester derivatives may include trimethyl phosphate, triethyl phosphate, tributyl phosphate, tris(2-ethylhexyl)phosphate, 2-ethylhexyldiphenyl phosphate, tributoxyethyl phosphate, triphenyl phosphate, crezyldiphenyl phosphate, isodecyldiphenyl phosphate, tricresyl phosphate, trixylenyl phosphate, tri(chloroethyl)phosphate, xylenyl diphenyl phosphate, and tetrakis(2,4-di-tertiary-butylphenyl)4,4′-biphenylen diphosphonate. In the present invention, a low-volatility carboxylic acid ester derivative having a boiling point of no less than 200° C. and excellent in thermostability and weather resistance may be specifically and preferably used to increase the weather resistance of the small-animal-controlling resin composition.

A specific example of the phosphazene derivative includes the cyclic phosphazene compound represented by the following general formula (4) [wherein, m stands for an integer of 3-25. R¹ and R² may be the same or different, and represent a C1-8 alkyl group and a phenyl group which may be substituted with a C1-8 alkyl group and/or allyl group].

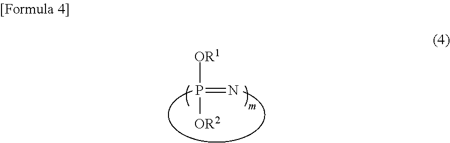

Further, the linear phosphazene compound represented by the following general formula (5) [wherein, n represents an integer from 3-1000. R³ and R⁴ may be the same or different, and represent a C1-8 alkyl group and a phenyl group which may be substituted with a C1-8 alkyl group and/or allyl group. X represents a group: N═P(OR³)₃, a group: —N═P(OR⁴)₃, a group: —N═P(O)(OR³), or a group: —N═P(O)(OR⁴). Y represents a group: —P(OR³)₄, a group: —P(OR⁴)₄, a group: —P(O)(OR³)₂, or a group: —P(O)(OR⁴)₂], and, at least one phosphazene compound selected from these phosphazene compounds is o-, m-, or p-phenylene group, or biphenylene group may be provided.

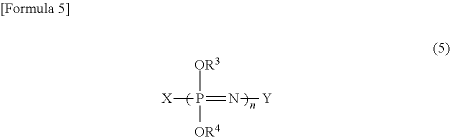

Furthermore, a phosphazene compound in which two oxygen atoms resulting from the releasing of alkyl group, and the like from substituents R¹, R², R³, and R⁴ are linked to each other by at least one crosslinking group selected from the group consisting of the group represented by the following general formula (6) [wherein, r is 0 or 1, and A represents a group: —SO₂—, —S—, —O—, or —C(CH₃)₂—] may be provided.

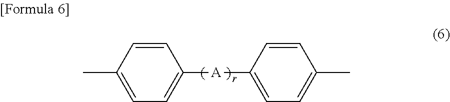

A specific example of the cyclic phosphazene compound represented by general formula (4) includes a cyclicn phosphazene compound such as hexaphenoxycyclotriphosphazene, octaphenoxycyclotetraphosphazene, decaphenoxycyclopentaphosphazene, hexapropoxycyclotriphosphazene, octapropoxycyclotetraphosphazene, and decapropoxycyclopentaphosphazene.

Further, a specific example of the linear phosphazene compound represented by general formula (5) includes straight phosphazene compounds having a chain dichlorphosphazene substituted with a propxy group and/or a phenoxy group.

A specific example of the crosslinking structure represented by general formula (6) includes 4,4′-sulfonyldiphenylene (bisphenol-S-residue), 4,4′-oxydiphenylene group, 4,4′-thiodiphenylene group, 4,4′-diphenylene group, and the like.

These phosphazene derivatives may have an amino group and/or a phenylamino group substituted in any position. These phosphazene derivatives maybe used singly, or a mixture of two or more may be used. Further, a mixture of the cyclic phosphazene and a linear phosphazene may be used.

Further, an example of the carboxylic acid amide derivative may include N-cyclohexylbenzoic acid amide and the like.

Further, an example of the sulfonamide derivative may include N-methyl-benzenesulfonamide, N-ethyl-benzenesulfonamide, N-butyl-benzenesulfonamide, N-cyclohexyl-benzenesulfonamide, N-ethyl-P-toluenesulfonamide, N-butyl-toluenesulfonamide, N-cyclohexyl-toluenesulfonamide, and the like.

Further, an example of the sulfonic acid ester derivative may include benzene sulfonic acid ethyl or the like. As the B component, one derivative selected from sulfonamide derivatives, sulfonic acid ester derivatives, carboxylic acid amide derivatives, carboxylic acid ester derivatives may be solely used, or a mixture of two or more selected from therefrom may be used.

### [Metal Oxide Fine Particles]

The metal oxide fine particles of the present invention have an average particle diameter of 1-100 nm and a high light transparency in the visible light region, and, have the property which blocks ultraviolet light. Note that, the metal oxide fine particles which block ultraviolet light mean metal oxide fine particles in which the maximum absorption wavelength is in the range of 200-450 nm, and more preferably in the range of 250-420 nm, therefore, it is thought that such metal oxide fine particles hence can absorb ultraviolet light to inhibit the rays from passing through.

Examples of the type of metal oxide fine particle may include titanium oxide (maximum absorption wavelength 420 nm), zinc oxide (maximum absorption wavelength 380 nm), and cerium oxide (maximum absorption wavelength 400 nm). Thereamong, titanium oxide and zinc oxide, which have no absorption in the visible light region are preferred. For use in applications where complete transparency in the visible light region is required, zinc oxide is more preferred. Incidentally, metal oxide fine particles can be prepared from a metal-oxide precursor having the constituent metal. Specifically, in the case where the metal oxide to be yielded is, for example, zinc oxide (ZnO), the metal oxide can be prepared by subjecting a metal salt such as zinc acetate, zinc nitrate, or zinc chloride to hydrolysis (hydrothermal synthesis, etc.) or pyrolysis. The kind of salt is not particularly limited, and examples thereof include acetate, nitrate, chloride, bromide, fluoride, cyanide, diethylcarbamate, oxalate, perchlorate, and trifluoroacetate. Thereamong, acetate and nitrate are preferred because these salts have a relatively low heat decomposition temperature. Note that, such precursors may be anhydrides or may be hydrates.

The average particle diameter of the metal oxide fine particles is preferably 1 to 100 nm, more preferably 1 to 50 nm, even more preferably 1 to 20 nm, from the viewpoint of the transparency of molded products to be obtained from the composition. It is preferred that the fine particles B should have a narrower particle size distribution.

The metal oxide fine particles B to be used are manufactured by a well-known method, but the metal oxide fine particles B obtained by manufacturing methods such as the hydrothermal synthesis method or the sol-gel method are preferred because aggregates are easily generated when particles in a solid state are added to and dispersed in a solution. The fine particles obtained by the manufacturing method can be mixed with resins while maintaining the dispersed state of the primary particles.

Further, the metal oxide fine particles are preferably subjected to a surface treatment from the viewpoint of making the dispersability to the base resin, the small-animal-controlling agent, and the sustained release auxiliary for the small-animal-controlling agent satisfactory.

The surface treatment agent of the metal oxide fine particles is not specifically limited, as long as the dispersability in the base resin, the small-animal-controlling agent, and the sustained release auxiliary for the small-animal-controlling agent increases. An example of the surface treatment agent may include a silane coupling agent such as amino silane, epoxy silane and acrylic silane, or a titanate coupling agent.

Methods for the surface treatment are not particularly limited, and the surface treatment may be conducted by known methods. Examples thereof include a method in which metal oxide fine particles prepared beforehand and a surface-treating agent are stirred in a solvent at −10 to 30° C. for 6 to 24 hours (sol-gel method) and a method in which a precursor for metal oxide fine particles and a surface-treating agent are stirred in a solvent at 200 to 300° C. for 0.1 to 1 hour (wet method). Note that, in the case where zinc oxide particles are synthesized by the hydrothermal method, treatment with a surface-treating agent may be conducted simultaneously with particle generation, and the particles can be thereby rendered dispersible in the silicone resin, while maintaining the particle dispersability.

The content of metal oxide fine particles is preferably 1-12 parts by weight and more preferably 2-10 parts by weight per 100 parts by weight total of the base resin. If no more than 1 part by weight, the effect which blocks ultraviolet light cannot be sufficiently obtained, and further, when no less than 12 parts by weight, the resin composition becomes too hard and the handling ability becomes poor.

### [Inorganic Filler]

Additionally, a predetermined amount of inorganic filler may be added to the small-animal-controlling resin composition according to the embodiment to increase the mechanical strength of the small-animal-controlling resin molded article. A particulate inorganic filler, a fibrous inorganic filler, or a flaky inorganic filler maybe used as the inorganic filler.

Examples of the particulate inorganic filler may include potassium titanate particles, titania particles, monoclinic system titania particles, silica particles, calcium phosphate, and the like, and these may be used solely or mixed with each other. Among these particulate inorganic fillers, potassium titanate particles are specifically preferable.

A fibrous inorganic filler having an average fiber diameter of 0.05 to 10 μm and an average fiber length of 3 to 150 μm are preferable, and a fibrous inorganic filler having an average fiber diameter of 0.1-7 μm and an average fiber length of 5-50 μm are preferably used, and potassium 4-titanate fiber, potassium 6-titanate fiber, potassium 8-titanate fiber, titania fiber, monoclinic titania fiber, silica fiber, wollastonite and zonotlite may be used as the fibrous inorganic filler. These may be used solely or mixed with each other. Among these fibrous inorganic fillers, the potassium 8-titanate fiber is most preferable.

Examples of the flaky inorganic filler may include potassium titanate, potassium lithium titanate, potassium titanate magnesium, talc, synthetic mica, natural mica, sericite, plate-like alumina, boron nitride, and the like, and these may be used solely or mixed with each other. Among the flaky inorganic fillers, potassium titanate is specifically preferable. When blending these inorganic fillers, the sustained release may be continued over a long period of time. Further, the blending of the inorganic filler also contributes to the improvement of the mechanical properties.

Note that, the inorganic filler may be used as is, but it may be subjected to surface treatment with a surface treatment agent such as a silane coupling agent such as amino silane, epoxy silane, and acrylic silane or a titanate coupling agent in order to improve the interfacial adhesion with the resin and further improve the mechanical properties.

### [Organic Weatherproofing Agent]

An organic weatherproofing agent may be further added to the small-animal-controlling resin composition of the present invention in order to increase the weather resistance. Examples of the organic weatherproofing agent include one or more selected from the group consisting of hindered phenol-based antioxidants, phosphorous-based antioxidants, UV-absorbing light stabilizers, hindered amine light stabilizers, and carbon.

Examples of the hindered phenol-based antioxidants include pentaerythritoltetrakis[3-(3,5-di-tert-butyl-4-hydroxyphenyl)propionate], N,N′-hexane-1,6-diylbis[3-(3,5-di-tert-butyl-4-hydroxyphenylpropionamide)], bis-[3,3-bis(4′-hydroxy-3′-tert-butyl-phenyl)-butanoic acid]-glycol ester, tris(3,5-di-tert-butyl-4-hydroxybenzyl)isocyanurate, thiodiethylene bis[3-(3,5-di-tert-butyl-4-hydroxyphenyl)propionate], octadecyl-3-(3,5-di-tert-butyl-4-hydroxyphenyl)propionate, 3,3′,3″,5,5′,5″-hexa-tert-butyl-a,a′,a″-(methylene-2,4,6-triyl)tri-p-cresol, hexamethylenebis[3-(3,5-di-tert-butyl-4-hydroxyphenyl)propionate], tetrakis[methylene-3-(3,5-di-tert-butyl-4-hydroxyphenyl)propionate]methane, and methylene-3-(3,5-di-tert-butyl-4-hydroxyphenyl)propionate.

Examples of the phosphorous-based antioxidants include tris(2,4-di-tert-butyl-phenyl)phosphite, tris[2-[[2,4,8,10-tetra-tert-butyl-benzo[d,f][1,3,2]dioxaphosphepin-6-yl]oxy]ethyl]amine, tetrakis(2,4-di-tert-butyl-phenyl) [1,1-biphenyl]-4,4′-diylbisphosphonite, distearyl pentaerythritol diphosphite, bis(2,4-di-tert-butyl-phenyl)pentaerythritol phosphite, bis(2,6-di-tert-butyl-4-phenyl)pentaerythritol phosphite, and bis(2,4-di-tert-butyl-phenyl)pentaerythritol diphosphite.

Examples of the ultraviolet light absorbers include 2-(2H-benzotriazole-2-yl)-4,6-bis(1-methyl-1-phenylethyl)phenol, 2-(2H-benzotriazole-2-yl)-4,6-di-tert-pentylphenol, propanedioic acid, and [(4-methoxyphenyl)-methylene]-dimethyl ester.

Examples of the hindered amine light stabilizers include N,N′,N″,N′″-tetrakis(4,6-bis(butyl-(Nmethyl-2,2,6,6-tetramethyl piperidine-4-yl)amino)-triazine-2-yl)-4,7-diazadecane-1,10-dimine, poly[(6-(1,1,3,3-tetramethyl-butyl)amino-1,3,5-triazine-2,4-diyl) (2,2,6,6-tetramethyl-4-piperidyl)imino]hexamethylene((2,2,6,6-tetramethyl-4-piperidyl)imino)), bis(2,2,6,6-tetramethyl-4-piperidyl) sebacate, 2,2,4,4-tetramethyl-7-oxa-3,20-diaza-dispiro-[5.1.11.2]-heneicosan-21-one, propanedioic acid, [(4-methoxyphenyl)-methylene], bis(1,2,2,6,6-pentamethyl-4-piperidinyl)ester, 1,3-benzene dicarboxylamide, N,N-bis(2,2,6,6-tetramethyl-4-piperidinyl), 2-ethyl, and 2′-ethoxy-oxalanilide.

The above mentioned organic weatherproofing agents can be used solely or mixed together. Thereamong, from the viewpoint that the compatibility with the base resin and the inhibition of film formation are superior, pentaerythritol tetrakis[3-(3,5-di-tert-butyl-4-hydroxyphenyl)propionate], N,N′-hexane-1,6-diylbis[3-(3,5-di-tert-butyl-4-hydroxyphenylpropionamide)], tris(3,5-di-tert-butyl-4-hydroxybenzyl)isocyanurate, tris(2,4-di-tert-butyl-phenyl)phosphite, tetrakis(2,4-di-tert-butyl-phenyl)[1,1-biphenyl]-4,4′-diylbisphosphonite, bis(2,4-di-tert-butyl-phenyl)pentaerythritol phosphite, 2-(2H-benzotriazole-2-yl)-4,6-bis(1-methyl-1-phenylethyl)phenol, 2-ethyl, 2′-ethoxy-oxalanilide, N,N′,N″,N′″-tetrakis-(4,6-bis(butyl-(N-methyl-2,2,6,6-tetramethyl piperidine-4-yl)amino)-triazine-2-yl)-4,7-diazadecane-1,10-diamine, poly[(6-(1,1,3,3-tetramethylbutyl)amino-1,3,5-triazine-2,4-diyl) (2,2,6,6-tetramethyl-4-piperidyl)imino]hexamethylene((2,2,6,6-tetramethyl-4-piperidyl)imino)), 1,3-benzene dicarboxyamide, and N,N′-bis(2,2,6,6-tetramethyl-4-piperidinyl) can be suitably used.

Further, it is desirable that the content of the small-animal-controlling agent in the small-animal-controlling resin composition of the present invention is no less than 1 wt % and no more than 50 wt % relative to the total amount of the small-animal-controlling resin composition. If the content is less than 1 wt %, the repellant effect on small-animals decreases, and the continuity of the effect decreases. However, if the content exceeds 50 wt %, manufacturing the small-animal-controlling resin composition becomes difficult.

The small-animal-controlling resin composition of the present invention may be manufactured for example by mixing the respective components together, and then melting and kneading the same. The respective components may be mixed together by dry-blending technique using a tumbler, blender, mixer, etc. Alternatively, the mixing of these components may be made by the feeding of the components through the same hopper or different hoppers of a kneading machine. The obtained small-animal-controlling resin composition may be directly formed into a desired shape and used as a small-animal-controlling resin molded article which is the product, or may be formed into pellets by a pelletizer immediately after extrusion for storage and distribution. The composition formed as a pellet may be formed by a known method.

When molding the small-animal-controlling resin molded article, a suitable well-known molding method, for example, injection molding, extrusion molding, press molding, blow molding, and a machine technique can be used. The shape of the small-animal-controlling resin molded article which is the product is not specifically limited, and can be made to any shape such as a flat plate, a rod, a cylinder, a comb, and a sphere. Further, in addition to integrally molding the small-animal-controlling resin composition, the molding of two or more colors combined with metals and the like may be performed.

Below, Examples 1-3 are provided to clarify the effect of the small-animal-controlling resin composition according to the present invention.

### Example 1

Example 1 is a test example for obtaining the relationship between the average particle diameter of the metal oxide fine particles added into the small-animal-controlling resin composition, the visible light transmittance of the small-animal-controlling resin molded article, and the strength retention of the small-animal-controlling resin molded article after UV-irradiation.

A sheet-like body having a thickness of 0.2 mm obtained by press molding the small-animal-controlling resin composition obtained by adding various titanium oxide fine particles having different average particle diameters to the compositions shown in Compositions 1-6 of Table 1 was used as the sample. With respect to the base resin, Compositions 1-6 were the same, and were made as the configuration containing 60 parts by weight of LD-PE (low density polyethylene resin) as the matrix resin, 10 parts by weight of EEA (ethylene-ethylacrylate copolymer) as the affinity resin, 15 parts by weight of PA6/66/12 copolymer as the carrier resin, and 5 parts by weight of PE-MAH (maleic anhydride-modified polyethylene) as the dispersion auxiliary resin. Further, with respect to the small-animal-controlling agent, Compositions 1-6 were also the same, and was made as a configuration containing 5 parts by weight of Etofenprox. Composition 1 was obtained by adding 5 parts by weight of benzenesulfonic acid amide as the sustained release auxiliary. Composition 2 was obtained by adding 5 parts by weight of adipic acid ester as the sustained release auxiliary. Composition 3 was obtained by adding 5 parts by weight of stearic acid ester as the sustained release auxiliary. Composition 4 was obtained by adding 5 parts by weight of palmitic acid ester as the sustained release auxiliary. Composition 5 was obtained by adding 5 parts by weight of myristic acid ester as the sustained release auxiliary. Composition 6 was obtained by adding 5 parts by weight of trimellitic acid ester as the sustained release auxiliary.

TABLE 1

| | Preparation | | | | | | | | | | | |
|---|---|---|---|---|---|---|---|---|---|---|---|---|
| | | | | | Resin | | | | | | | |
| | Small-animal-controlling | | Sustained release | | | | | | | | Dispersion | |
| | agent | | auxiliary | | Matrix resin | | Affinity resin | | Carrier resin | | auxiliary resin | |
| | | Parts by | | Parts by | | Parts by | | Parts by | | Parts by | | Parts by |
| Example | Material | weight | Material | weight | Material | weight | Material | weight | Material | weight | Material | weight |
| Ex. 1 | Etofenprox | 5 | Benzenesulfonic | 5 | LD-PE | 60 | EEA | 10 | PA6/66/12 | 15 | PE-MAH | 5 |
| | | | acid amide | | | | | | copolymer | | | |
| Ex. 2 | Etofenprox | 5 | Adipic acid | 5 | LD-PE | 60 | EEA | 10 | PA6/66/12 | 15 | PE-MAH | 5 |
| | | | ester | | | | | | copolymer | | | |
| Ex. 3 | Etofenprox | 5 | Stearic acid | 5 | LD-PE | 60 | EEA | 10 | PA6/66/12 | 15 | PE-MAH | 5 |
| | | | ester | | | | | | copolymer | | | |
| Ex. 4 | Etofenprox | 5 | Palmitic acid | 5 | LD-PE | 60 | EEA | 10 | PA6/66/12 | 15 | PE-MAH | 5 |
| | | | ester | | | | | | copolymer | | | |
| Ex. 5 | Etofenprox | 5 | Myristic acid | 5 | LD-PE | 60 | EEA | 10 | PA6/66/12 | 15 | PE-MAH | 5 |
| | | | ester | | | | | | copolymer | | | |
| Ex. 6 | Etofenprox | 5 | Trimellitic | 5 | LD-PE | 60 | EEA | 10 | PA6/66/12 | 15 | PE-MAH | 5 |
| | | | acid ester | | | | | | copolymer | | | |

Regarding the testing, the abovementioned sheet-like sample was irradiated with ultraviolet light for 100 hours using a metal halide lamp testing machine (EYE SUPER UV TESTER SUV-W231 manufactured by Iwasaki Electric Co., Ltd), a Dumbbell No. 8 shape was used for the sheet-like sample after UV-irradiation and a tensile test was performed at a tensile rate of 50 ram/min, and the strength retention was calculated.

The following Table 2 shows the relationship between the average particle diameter of the titanium oxide fine particles added to the small-animal-controlling resin composition, the visible light transmittance of the small-animal-controlling resin molded article, and the strength retention of the small-animal-controlling resin molded article after UV-irradiation.

TABLE 2
Difference between the transmittance and the strength
retention ratio after UV-irradiation due to the particle diameter
of the titanium oxide

| Filler particle | | Strength retention |
|---|---|---|
| diameter [μm] | Transmittance [%] | ratio [%] |
| — | 75 | — |
| 0.24 | 43 | 73 |
| 0.15 | 66 | 79 |
| 0.04 | 72 | 85 |
| 0.02 | 73 | 85 |
| Target value | No less than 70 | No less than 80 |

* At a transmittance of no less than 70%, the transparency was visually equivalent to that when no filler was added.
* If the strength retention ratio was no less than 80%, the product was usable as a net.

As is clear from Table 2, the visible light transmittance of the sheet-like sample was 75% in the case when no titanium oxide fine particles were added. Further, as is clear from Table 2, the lower the average particle diameter of the titanium oxide fine particles added to the small-animal-controlling resin composition, the higher the visible light transmittance becomes, thus, it is understood that it is necessary to add titanium oxide fine particles having an average particle diameter of 20-40 nm in order to obtain the same visible light transmittance as in the case when no titanium oxide fine particles were added. With respect to the strength retention, there is the tendency that the smaller the average particle diameter of the titanium oxide fine particles added to the small-animal-controlling resin composition, the higher the strength retention becomes. A strength retention of no less than 80% is suitable for the manufacture of a net-like small animal controlling molded article for use in a screen door and the like. Even when metal oxide fine particles other than titanium oxide were used, almost the same result was obtained.

### Example 2

Example 2 is a test example for obtaining the relationship between the combination of the organic weatherproofing agents and the metal oxide fine particles which are added in the small-animal-controlling resin composition and the strength retention of the small-animal-controlling resin molded article after UV-irradiation. The sample is the same as the sample of Test example 1, with the exception of the combination of the organic weatherproofing agents and the metal oxide fine particles shown in Table 3. Further, the testing methods were the same as with Test example 1.

The following Table 3 shows the relationship between the combination of the organic weatherproofing agents and the titanium oxide fine particles added in the small-animal-controlling resin composition and the strength retention of the small-animal-controlling resin molded article after UV-irradiation. Note that, HALS described in Table 3 indicates a hindered amine stabilizer.

TABLE 3
Difference between the strength retention rates of UV-reflection agents due to the combination of weatherproofing agents

| Organic weatherproofing agent | | | | | Inorganic | |
|---|---|---|---|---|---|---|
| | Benzotriazole-based | | | HALS weather | weatherproofing agent | |
| HALS light | ultraviolet light | Phosphorus heat | Hindered phenol- | resisting | Titanium oxide light | Strength |
| stabilizer | absorber | stabilizer | based antioxidant | stabilizer | reflecting agent | retention [%] |
| ◯ | | | | | | Not measurable |
| ◯ | ◯ | | | | | Not measurable |
| ◯ | ◯ | ◯ | | | | Not measurable |
| ◯ | ◯ | ◯ | | | | Not measurable |
| ◯ | ◯ | ◯ | | | | Not measurable |
| ◯ | ◯ | ◯ | | | | Not measurable |
| | | ◯ | ◯ | | | Not measurable |
| | | | | | ◯ | Not measurable |
| ◯ | ◯ | ◯ | | ◯ | | 49 |
| ◯ | ◯ | ◯ | | ◯ | ◯ | 84 |
| ◯ | ◯ | ◯ | ◯ | ◯ | ◯ | 87 |
| | | ◯ | ◯ | | ◯ | 45 |

As is clear from Table 3, the strength retention after UV-irradiation of the sheet-like samples which comprise only one or more organic weatherproofing agents selected from hindered amine light stabilizers, benzotriazole-based ultraviolet light absorbers, phosphorus heat stabilizers, and hindered phenol-based antioxidants and which do not comprise the inorganic titanium oxide fine particles could not be measured, thus, it is understood that these samples are not suitable for practical use as the small-animal-controlling resin composition for outdoor use.

Further, the strength retention after UV-irradiation of the sheet-like sample which comprises only the inorganic titanium oxide fine particles, and which does not comprise the organic weatherproofing agent could not be measured.

Furthermore, the strength retention after UV-irradiation of the sheet-like sample which comprises a hindered amine light stabilizer, a benzotriazole-based ultraviolet light absorber, phosphorus heat stabilizer, and a hindered amine weather resisting stabilizer as the organic weatherproofing agents but which does not comprise titanium oxide fine particles is as low as 49%, and the performance was insufficient as a small-animal-controlling resin composition for outdoor use.

Further, the strength retention after UV-irradiation of the sheet-like sample comprising titanium oxide fine particles, but in which the organic weatherproofing agent is only a phosphorus heat stabilizer and a hindered amine weather resisting stabilizer is also as low as 45%, and the performance was insufficient as a small-animal-controlling resin composition for outdoor use.

With respect thereto, the strength retention after UV-irradiation of sheet-like samples comprising a hindered amine light stabilizer, a benzotriazole-based ultraviolet light absorber, a phosphorus heat stabilizer, and a hindered amine weather resisting stabilizer as the weatherproofing agents, and comprising at least titanium oxide fine particles as the inorganic weatherproofing agent is as high as 84% and 87%, and had sufficient performance as the small-animal-controlling resin composition for outdoor use.

### Example 3

Example 3 is a test example for obtaining the relationship between the boiling point of each sustained release auxiliary added to the small-animal-controlling resin composition and the strength retention of the small-animal-controlling resin molded article after UV-irradiation. The sample was the same as the sample of Test example 1. Further, the testing methods were the same as with Test example 1.

The following Table 4 shows the relationship between the type of sustained release auxiliary added in the small-animal-controlling resin composition, the boiling point of each sustained release auxiliary, and the strength retention of the small-animal-controlling resin molded article after UV-irradiation.

TABLE 4
Difference of strength retention ratio after UV-irradiation
due to the sustained release auxiliary

| Sustained Release | | Strength Retention |
|---|---|---|
| Auxiliary | Boiling Point [° C.] | [%] |
| Benzenesulfonic acid | 160 | 28 |
| amide | | |
| Adipic acid ester | 293 | 76 |
| Stearic acid ester | 368 | 82 |
| Palmitic acid ester | 160 | 57 |
| Myristic acid ester | 193 | 49 |
| Trimellitic acid | 414 | 83 |
| ester | | |

* Strength retention at a boiling point of 300° C. was no less than 80%

As is clear from Table 4, there is the tendency that the more high boiling point sustained release auxiliary added, the more the strength retention of the small-animal-controlling resin molded article after UV-irradiation increases. Specifically, if a sustained release auxiliary having a boiling point of no less than 300° C. is added, the strength retention of the small-animal-controlling resin molded article after UV-irradiation was no less than 80%.

### INDUSTRIAL APPLICABILITY

The present invention can be used in a small-animal-controlling resin molded article for controlling numerous agricultural pests, sanitary insects, and other insects, and small animals such as arachnids, mites, and mice.

1. An small-animal-controlling resin composition comprising at least a base resin, a small-animal-controlling agent, a sustained release auxiliary for the small-animal-controlling agent, an organic weatherproofing agent, and metal oxide fine particles as an inorganic weatherproofing agent.

2. The small-animal-controlling resin composition according to claim 1, wherein the metal oxide fine particles have an average particle diameter of 1-100 nm.

3. The small-animal-controlling resin composition according to claim 1, wherein the metal oxide fine particles have a maximum absorption wavelength of 200-450 nm.

4. The small-animal-controlling resin composition according to claim 1, wherein the surfaces of the metal oxide fine particles are subjected to a surface treatment using a surface treatment agent comprising an organic material.

5. The small-animal-controlling resin composition according to claim 1, wherein a low volatility carboxylic acid ester derivative having a boiling point of no less than 200° C. is used as the sustained release auxiliary for the small-animal-controlling agent.

6. The small-animal-controlling resin composition according to claim 1, wherein the metal oxide fine particles have an average particle diameter of 1-100 nm and a maximum absorption wavelength of 200-450 nm.

7. The small-animal-controlling resin composition according to claim 1, wherein the metal oxide fine particles have an average particle diameter of 1-100 nm, and the surfaces thereof are subjected to a surface treatment using a surface treatment agent comprising an organic material.

8. The small-animal-controlling resin composition according to claim 1, wherein the metal oxide fine particles have an average particle diameter of 1-100 nm, and
a low volatility carboxylic acid ester derivative having a boiling point of no less than 200° C. is used as the sustained release auxiliary for the small-animal-controlling agent.

9. The small-animal-controlling resin composition according to claim 1, wherein the metal oxide fine particles have an average particle diameter of 1-100 nm and a maximum absorption wavelength of 200-450 nm, and the surfaces thereof are subjected to a surface treatment using a surface treatment agent comprising an organic material.

10. The small-animal-controlling resin composition according to claim 1, wherein the metal oxide fine particles have an average particle diameter of 1-100 nm and a maximum absorption wavelength of 200-450 nm, and
a low volatility carboxylic acid ester derivative having a boiling point of no less than 200° C. is used as the sustained release auxiliary for the small-animal-controlling agent.

11. The small-animal-controlling resin composition according to claim 1, wherein the metal oxide fine particles having an average particle diameter of 1-100 nm, and the surfaces thereof are subjected to a surface treatment using a surface treatment agent comprising an organic material, and
a low volatility carboxylic acid ester derivative have a boiling point of no less than 200° C. is used as the sustained release auxiliary for the small-animal-controlling agent.

12. The small-animal-controlling resin composition according to claim 1, wherein the metal oxide fine particles have an average particle diameter of 1-100 nm and a maximum absorption wavelength of 200-450 nm, and the surfaces thereof are subjected to a surface treatment using a surface treatment agent comprising an organic material, and
a low volatility carboxylic acid ester derivative having a boiling point of no less than 200° C. is used as the sustained release auxiliary for the small-animal-controlling agent.

13. The small-animal-controlling resin composition according to claim 1, wherein the metal oxide fine particles have a maximum absorption wavelength of 200-450 nm, and the surfaces thereof are subjected to a surface treatment using a surface treatment agent comprising an organic material.

14. The small-animal-controlling resin composition according to claim 1, wherein the metal oxide fine particles have a maximum absorption wavelength of 200-450 nm, and
a low volatility carboxylic acid ester derivative having a boiling point of no less than 200° C. is used as the sustained release auxiliary for the small-animal-controlling agent.

15. The small-animal-controlling resin composition according to claim 1, wherein the metal oxide fine particles have a maximum absorption wavelength of 200-450 nm, and the surfaces thereof are subjected to a surface treatment using a surface treatment agent comprising an organic material, and
a low volatility carboxylic acid ester derivative having a boiling point of no less than 200° C. is used as the sustained release auxiliary for the small-animal-controlling agent.

16. The small-animal-controlling resin composition according to claim 1, wherein the surfaces of the metal oxide fine particles are subjected to a surface treatment using a surface treatment agent comprising an organic material, and
a low volatility carboxylic acid ester derivative having a boiling point of no less than 200° C. is used as the sustained release auxiliary for the small-animal-controlling agent.
